(19) United States
(12) Patent Application Publication
(10) Pub. No.: US 2004/0030047 A1
(43) Pub. Date: Feb. 12, 2004

(54) Use of poly (meth) acrylate units containing suphonate groups in binding agents for magnetic storage media

(76) Inventors: Ulrike Hees, Mannheim (DE); Hans-Guenter Bohrmann, Ludwigshafen (DE); Benedikt Raether, Limburgerhof (DE); Ria Kress, Ludwigshafen (DE); Albert Kohl, Laumersheim (DE); Lothar Schulz, Nussloch (DE)

Correspondence Address: GREENBLUM & BERNSTEIN, P.L.C., 1950 ROLAND CLARKE PLACE, RESTON, VA, 20191, US

(21) Appl. No.: 10/450,523

(22) PCT Filed: Dec. 19, 2001
(86) PCT No.: PCT/EP01/15072

(30) Foreign Application Priority Data
Dec. 22, 2000 (DE) 10064299.3

(51) Int. Cl. C08L 51/00

(52) U.S. Cl. 525/77

(57) ABSTRACT

The invention relates to a polyurethane comprising at least one anionic active group L. The anionic active group L is bound to a segment G in the polyurethane, said segment containing monomers that have been linked by radical polymerisation. The invention also relates to a binding agent composition containing an inventive polyurethane, to a method for the production thereof and to the use of polyurethanes of this type for producing magnetic recording media.

The invention relates to a polyurethane containing anchor groups, a method for its production, its use, as well as binding agent compositions and molded articles produced therefrom. A binding agent composition according to the invention contains at least one polyurethane according to the invention that features at least one anionic anchor group L, whereby the anchor group L is bound in the polyurethane to a segment G that contains monomers linked by radical polymerization. The invention relates in particular to the use of binding agent compositions containing such polyurethanes or molded articles produced from such binding agent compositions for the production of magnetic recording media.

Magnetic recording media are given a great deal of attention in the context of the permanent storage of information. A magnetic recording medium customarily comprises a non-magnetic supporting material and at least one magnetizable layer applied adhesively to it, which layer is based on polymer binding agents and magnetic pigments dispersed therein. Continually increasing demands are made on magnetic recording media with respect to quality of the recording and reproduction, as well as on resistance to aging, due to the ever growing requirement for storage for information and the concomitant increase in the information density on a specific storage medium. In order to meet these demands, increasing importance is being placed on the polymer binding agent in which the magnetic pigments are dispersed. The goal is to improve the stability of the magnetic dispersion, to avoid the formation of defects on the magnetic layer, and to improve the magnetic properties, in particular the remanence, to increase the packing density of the magnetic pigments in the magnetic layer, which can be achieved for example by a reduction of the proportion of binding agent combined with an increase in the proportion of pigment in this layer.

However, the measures named make it more difficult both to distribute the pigments in the dispersing process and to achieve a good dispersion stability. In addition, the magnetic layers must be very flexible, feature a high elasticity, and have a high tear resistance. Moreover, a reduction in the friction values and an increase in the abrasion- and wear-resistance of the magnetic layer is also increasingly required, to avoid breakdowns in the level. These mechanical properties must be guaranteed even at high temperature and high air humidity.

It is known that various groups of substances are suitable as polymers for the production of magnetic recording media. Thus far polyurethanes, which above all clearly improve the elasticity of the magnetic recording media or of coatings of such magnetic recording media, have proved to be particularly advantageous. Their low hardness and abrasion resistance have frequently proved to be disadvantageous in the polyurethanes, however.

The use of ionic groups such as metal sulfonate groups, metal salts of phosphonates and phosphate salts of amines improves the dispersing properties of such binding agents. Such effects were described in various patents (U.S. Pat. No. 5,747,630, JP 59-8127, JP 57-3134, JP 58-41564, JP 61-48122). The insertion of low-molecular ionic groups into a slightly polar solvent-containing binding agent system is only possible to a limited extent, due to the low solubility of the ionic groups. As described in DE 34 07 563, Tegomer DS 3117 (Th. Goldschmidt AG company) is among the few components that exhibit good solubility in organic solvents. This sulfonate-group-containing diol contains a long polyethylene glycol segment in the side chain that increases the hydrophilia of the binding agents synthesized from it and can lead to adverse effects in the tape.

U.S. Pat. No. 4,477,531 describes a magnetic recording medium with a polyurethane binding agent without reactive groups, produced from a polyester, a glycol, and a diisocyanate. A polyacrylate is mentioned only as an additional binding agent, i.e. the compound is merely added and mixed in.

In GB 1339930, a reaction product of monofunctional polymethacrylates with di-, tri-, or tetraisocyanates is described. No sulfonate-containing groups or other functionalities in the polymethacrylate segment are described that can lead to a branching or a block structure.

The structure of polyisocyanates that contain a block obtained by regulated radical polymerization was described for example in U.S. Pat. No. 3,788,996, U.S. Pat. No. 4,032,689, or U.S. Pat. No. 4,070,388. Here, however, acid or basic anchor groups are introduced only subsequently, which complicates the method.

EP-B 0 547 432 relates to magnetic recording supporting material with a binding agent mixture of a polyurethane urea (meth)acrylate and a polyurethane. However, the (meth)acrylates named here do not have anchor groups, so that additional auxiliary agents must be used to produce the magnetic recording supporting material.

U.S. Pat. No. 5,695,884 describes thermoplastic polyurethanes with metal sulfonate groups, whereby the polyurethanes comprise at least one polyester polyol, a low-molecular diol, and an organic diisocyanate.

In EP-B 0 465 070, sulfonated and non-sulfonated thio- and hydroxy-functionalized polyurethanes and graft copolymers produced therefrom are described, as well as the use of these polymers for magnetic recording media.

DE-C 28 33 845 relates to magnetic recording media with binding agents containing a polyester or a polyurethane with a metal sulfonate groups content of 10 to 1000 equivalents/10⁶ g of polymer, whereby the described polymer can be used in mixtures with thermoplastic or heat-hardenable resins.

EP-B 0 463 805 relates to hydroxy-functionalized polyurethanes with sulfonate groups that are modified with dithiocarbamate. Moreover, in EP-B 0 463 805 graft copolymers of hydroxy-functionalized polyurethanes with sulfonate groups with vinyl polymers are described, as well as the use of the copolymers as magnetic recording media. Polyurethanes with anchor groups are also described in DE-A 199 45 400.0, which relates to a thermoplastic block copolymer with at least one soft segment A and at least one hard segment B, whereby the hard segment B features at least one anionic and/or at least one cationic anchor group L.

Furthermore, a binding agent composition that at least contains one polyurethane with a structural unit according to the general formula I

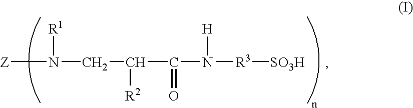

where n stands for a number from 1 to 10, the radicals R¹ independently of one another respectively stand for a polyurethane with a molecular weight of at least about 1000, R⁴-Q- R⁴-Q-(X-O-)ₘX-Q- or R⁴-Q-Y-Q-, where Q stands for O, NH, NR², or S, R⁴ stands for a linear or branched, saturated or unsaturated alkyl radical with 2 to 44 C atoms, X stands for an optionally aromatically substituted alkyl radical with 2 to 14 C atoms, Y stands for a polymer obtainable by polymerization, polyaddition, or polycondensation and with a molecular weight M_{w} of 150 to 5000, and m stands for a value of 1 to 300, the radicals R² independently of one another respectively stand for H or a linear or branched, saturated or unsaturated aliphatic hydrocarbon radical with 1 to about 20 C atoms, a saturated or unsaturated, optionally substituted cycloaliphatic hydrocarbon radical with 4 to about 20 C atoms, an optionally substituted araliphatic hydrocarbon radical with 6 to about 20 C atoms, or an optionally substituted aromatic hydrocarbon radical with 6 to 18 C atoms, the radicals R³ stand for a linear or branched, saturated or unsaturated alkyl radical with 2 C atoms or a saturated or unsaturated cycloalkyl radical with 4 to 44 C atoms, Z stands for a linear or branched, saturated or unsaturated, optionally substituted alkyl radical with 8 to 44 C atoms, an optionally substituted cycloalkyl radical with 4 to 44 C atoms, an optionally substituted araliphatic hydrocarbon radical with 6 to 40 C atoms, or a polymer obtainable by polymerization, polyaddition, or polycondensation and with a molecular weight M_{w}, of 150 to 5000, whereby Z is bound to the total molecule via suitable functional groups, or a partial or full salt thereof, and at least one magnetic or magnetizable pigment, are known from DE-A 100 05 647.4.

DE-A 100 05 649.0 also relates to a binding agent composition containing a polyurethane with a structural unit according to the general formula I

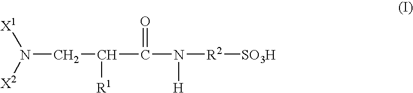

where R¹ stands for H or a linear or branched, saturated or unsaturated aliphatic hydrocarbon radical with 1 to 20 C atoms, a saturated or unsaturated, optionally substituted cycloaliphatic hydrocarbon radical with 4 to 20 C atoms, or an optionally substituted araliphatic hydrocarbon radical with 6 to 40 C atoms, R¹ stands for a linear or branched, saturated or unsaturated aliphatic hydrocarbon radical with 1 to 20 C atoms or a cycloaliphatic hydrocarbon radical with 4 to 20 C atoms or an optionally substituted aromatic hydrocarbon with 6 to 18 C atoms, X¹ and X² independently of one another respectively stand for an optionally substituted radical including at least two C atoms, whereby at least one of the radicals X¹ and X² is bound into the polyurethane by reaction of an OH—, NH₂—, NHR³, or SH group where R³ stands for a linear or branched, saturated or unsaturated, optionally aromatically substituted alkyl radical with 1 to 44 C atoms or a salt thereof, and at least one magnetic or magnetizable pigment.

DE-A 100 50 710.7 relates to a polyurethane containing anchor groups, whereby the anchor group is bound covalently to a polyether segment in the polyurethane featuring a nitrogen atom, a method for its production, its use, and binding agents and molded articles produced therefrom.

It is advantageous in the synthesis of abrasion-resistant polyurethanes in a defined manner to insert polar functional groups into the polymer, without being limited, as for example in the use of low-molecular diols with polar groups, to polar solvents such as water.

The object of the present invention was therefore to make available a new polymer in which the insertion of functionalized blocks into the polyurethane can take place in various organic solvents.

The subject of the invention is therefore a polyurethane with at least one anionic anchor group L, whereby the anchor group L is bound in the polyurethane to a segment G that contains monomers linked by radical polymerization.

A “segment G that contains monomers linked by radical polymerization” is understood in the scope of the invention to mean a segment that includes at least two monomer units, whereby these monomer units can be the same or different. Such a segment is built up from unsaturated monomers via regulated radical polymerization. In the scope of the invention, the segment G also features at least two further functional groups, in particular hydroxy or thiol groups, amines or other groups reactive with NCO groups, which can be the same or different, via which it can be built up further into a polyurethane.

A binding agent composition is understood in the scope of the present invention to mean a mixture of preferably two or more polymers that, after chemical or physical drying has taken place, are materially involved in obtaining stable dispersions and in an adequate mechanical stability of a magnetic recording medium produced from the binding agent composition. According to the invention, however, a binding agent composition can also contain only one polymer and further additives.

In the scope of the present invention, a binding agent is thereby understood to mean a polymer or a mixture of two or more polymers.

In the scope of the present invention, a thermoplastic block copolyurethane is understood to mean a polyurethane that features a block build-up of the structure, for example A-B-A, whereby these individual blocks are present in separate microphases. At a certain temperature or within a certain temperature range, the thermoplastic block copolyurethane features a softening point or a softening range. Above this softening point or range the polyurethane is plastically deformable, whereby when it returns to temperatures below this softening point or range, it retains the shape produced in the plastic state and behaves essentially like a duromer.

In the scope of the present invention, a hard segment A is understood to mean a segment of a polyurethane molecule, preferably a thermoplastic polyurethane molecule, whereby the hard segment features a glass transition temperature above at least about 20 to 40° C., preferably at least about 50° C.

In the scope of the present invention, a soft segment B is understood to mean a segment of a polyurethane molecule that is bound covalently to a hard segment and features a glass transition temperature of less than about 40° C.

In the scope of the present invention, an anchor group L is understood to mean an anionic group that is capable of interactions with ionic or at least polar compounds. In particular, anchor groups are understood to mean those functional groups that are capable of entering into interactions with the surface of inorganic filler materials, in particular with the surface of inorganic magnetic or magnetizable pigments.

The polyurethanes according to the invention feature at least one anionic anchor group L, whereby the anchor group L is bound in the polyurethane to a segment G that contains monomers linked by radical polymerization. In the scope of the invention, a polyurethane is understood to mean a mixture of individual polyurethane molecules. According to the invention, at least one molecule of the plurality of molecules constituting the polyurethane features at least one anionic anchor group L, whereby the anchor group L is bound in the polyurethane to a segment G that contains monomers linked by radical polymerization. According to the invention, however, it is equally possible for each of the molecules constituting the polyurethane to feature at least one anionic anchor group L.

A polyurethane according to the invention can thereby feature a random structure, i.e. it does not have to be a polyurethane built up in blocks. However, it is likewise provided in the scope of the present invention that a polyurethane according to the invention features segments of different hardness, in particular at least one soft segment and at least one hard segment.

In the scope of a preferred embodiment of the present invention, a polyurethane according to the invention features thermoplastic properties. In the scope of a further preferred embodiment of the present invention, the polyurethane according to the invention is a block copolyurethane.

According to the invention, the segment G with at least one anionic anchor group L can be specifically built into the hard segment or the soft segment. However, according to the invention the number of anchor groups situated in a hard segment A of the thermoplastic polyurethane is greater than the number of anchor groups situated in a soft segment B or several soft segments B. In a preferred embodiment of the invention, the number of anchor groups in the total number of the hard segments A in the polyurethane is at least five times as great, preferably at least 10 times as great, as the total number of anchor groups in the soft segments B. In a further preferred embodiment of the invention, the thermoplastic polyurethane according to the invention features essentially no anchor groups in the at least one soft segment B.

In a preferred embodiment of the compound, the polyurethane according to the invention contains as anchor group L a sulfonic acid group or a suitable salt of such a group.

Suitable compounds for the build-up of such a segment G with at least one anionic anchor group L are suitable α,β-unsaturated monomers, for example correspondingly functionalized acrylates or methacrylates, acrylamides or methacrylamides with polar functional groups, or polar or non-polar vinyl monomers. As functional groups, for example sulfonic acid groups or hydroxy groups are suitable. For example, blocks can be produced by copolymerization of a hydroxy-functionalized monomer with a sulfonic acid-carrying monomer, which blocks carry a sulfonic acid group and can then be reacted via the free OH groups, e.g., by reaction with corresponding diisocyanates to produce polyurethanes.

Monomers particularly suited to the build-up of a segment G with at least one anionic anchor group L are, for example, hydroxy(meth)acrylate, hydroxyalkyl (meth)acrylate, for example hydroxyethyl (meth)acrylate or hydroxypropyl (meth)acrylate, acrylamido-propanesulfonic acid (AMPS), methyl (meth)acrylate, and butyl (meth)acrylate. The blocks are preferably produced by regulated radical polymerization, for example with thioethanol. The composition of the blocks that are built up from different copolymerizable monomers can be estimated in a known manner by means of the copolymerization parameters.

In a preferred embodiment, the invention relates to a thermoplastic polyurethane with a structure of the general form I

-(AₖBₗ)ₙ- (I)

or in a further embodiment a polyurethane with branches of the general form II

-(A(B)ₘ)ₙ- (II),

where A stands for a hard segment and B stands for a soft segment, k and n respectively stand for a number from 1 to 10, and l and m stand for a number from 0 to 10, whereby k, l, and m can be selected for each repeat unit independently of the next repeat unit, and m or l preferably stand for a number from 1 to 10 in at least one repeat unit of the polyurethane according to the invention. Preferably m and l stand for a number from 1 to 10. A thermoplastic polyurethane of the general form II can be, for example, a polyurethane with a comb or star structure.

According to the invention, possible structures would therefore be, for example: -BAB-, -ABBA-, -AAB-, -A(BA-)₂.

When the polyurethane according to the invention features soft segments and hard segments, the segment G can be arranged in the soft segment or in the hard segment or in both segments.

In a preferred embodiment, the segment G is arranged in the hard segment A, so that the anionic anchor group L is also preferably present in the hard segment A. In particular, the polyurethane according to the invention thus has the general form Ia

-(Aₖ(L)ₚ-Bₗ)ₙ- (Ia)

or IIa

-(A(L)ₚ(B)ₘ)ₙ- (IIa),

where A stands for a hard segment, B stands for a soft segment, and L stands for an anchor group, and k and n respectively stand for a number from 1 to 10, and l and m stand for a number from 0 to 10, whereby k, l, and m can be selected for each repeat unit independently of the next repeat unit, and m or l preferably stand for a number from 1 to 10 in at least one repeat unit of the polyurethane according to the invention and p stands for a number greater than 0 to 10. Preferably m and l stand for a number from 1 to 10.

The named compounds suitable for use as hard segments A feature at least one functional group X, where X stands for a functional group that is reactive with a functional group Y, forming a covalent bond. In a preferred embodiment of the invention, the compounds suitable as hard segments A feature at least two functional groups X. In a further preferred embodiment of the invention, the functional groups X are attached as end groups to the compounds suitable for use as hard segment A.

In principle, X stands for a functional group capable of reacting preferentially with an NCO group, forming a covalent bond. In a preferred embodiment of the invention, X stands for OH, NH₂, NHR, NR₂, SH, or COOH, where R stands for a linear or branched, saturated or unsaturated alkyl radical with 1 to 24 C atoms or an aryl radical with 6 to 24 C atoms.

In a further preferred embodiment of the invention, X stands for an OH—, SH group or an amine, in particular for an OH group. Compounds suitable for the production of hard segments A will be described in the further course of the text. Unless stated otherwise, the compounds are represented as compounds carrying OH groups, for the sake of clarity. However, in the scope of the present invention it is equally possible to use corresponding compounds that carry another functional group that reacts preferentially with NCO groups instead of the OH group represented in the further description, for example one of the other functional groups named for X, in so far as a corresponding compound exists or can be produced.

Polymers suitable for the formation of hard segments are, for example, polymers from derivatives of acrylic acid or methacrylic acid, in particular (meth)acrylamides, with polar groups, or polar or non-polar vinyl monomers or a combination of two or more thereof or a combination of one or more of these monomers with at least one less polar monomer.

In principle, for example, polyesters, polyethers, polyacetals, polycarbonates, polyester ethers and the like, such as, e.g., polyester polyurethanes, are suitable for the build-up of soft segments B.

Polymers suitable for the formation of soft segments are, for example, predominantly linear polymers with OH end groups, preferably those with two or three, in particular with two OH end groups, which are then for example reacted with diisocyanates to produce the soft segment B. Polyester polyols are suitable, for example, which can be produced in a simple manner by esterification of linear or branched, saturated or unsaturated aliphatic or correspondingly suitable aromatic dicarboxylic acids with 4 to about 15 C atoms, preferably 4 to about 10 C atoms, with glycols, preferably glycols with about 2 to about 25 C atoms, or by polymerization of lactones with about 3 to about 20 C atoms. As dicarboxylic acids, for example glutaric acid, pimelic acid, suberic acid, sebacic acid, dodecanoic diacid, and preferably adipic acid or succinic acid, or mixtures of two or more of the named dicarboxylic acids, can be used. Suitable aromatic dicarboxylic acids are terephthalic acid, isophthalic acid, phthalic acid, or mixtures of two or more of these dicarboxylic acids. Tricarboxylic acids, such as, e.g., trimellitic acid, are also suitable. Mixtures of one or more of the named aromatic di- or tricarboxylic acids with aliphatic or further aromatic dicarboxylic acids, for example with diphenic acid, pentadienoic acid, succinic acid, or adipic acid, are likewise suitable.

For the production of the polyester polyols, it can optionally be advantageous in place of the dicarboxylic acids to use corresponding acid derivatives such as carboxylic acid anhydrides or carboxylic acid chlorides, if these are obtainable.

The polyester polyols suitable for use as a soft segment in the scope of the present invention can be produced by reaction of dicarboxylic acids with appropriate glycols. In principle, glycols suitable for the production of the polyester polyols are linear or branched, saturated or unsaturated, aliphatic or aromatic glycols. These are, for example, diethylene glycol, 1,2-ethanediol, 1,3-propanediol, 2-methyl-1,3-propanediol, 1,4-butanediol, 1,5-pentanediol, 1,6-hexanediol, 1,7-heptanediol, 1,8-octanediol, 1,9-nonanediol, 1,10-decanediol as well as the corresponding higher homologs, as can be formed by stepwise lengthening of the carbon chain of the named compounds, as well as, for example, 2,2,4-trimethyl-1,5-pentanediol, 2,2-dimethyl-1,3-propanediol, 1,4-cyclohexanedimethanol, 1,4-diethanolcyclohexane, 2-methyl-2-butyl-1,3-propanediol, 2,2-dimethyl-1,4-butanediol, hydroxypivalic acid neopentyl glycol ester, triethylene glycol, methyldiethanolamine, or aromatic-aliphatic or aromatic-cycloaliphatic diols with 8 to about 30 C atoms, whereby as aromatic structures, heterocyclic ring systems or preferably isocyclic ring systems such as naphthalene- or in particular benzene derivatives such as bisphenol A can be used, twice symmetrically ethoxylated bisphenol A, twice symmetrically propoxylated bisphenol A, higher ethoxylated or propoxylated bisphenol A derivatives or bisphenol F derivatives, the hydrogenation products of the named bisphenol A- and bisphenol F derivatives, or the products of the corresponding reaction of a compound or a mixture of two or more of the named compounds with an alkylene oxide with two to about 8 C atoms or a mixture of two or more such alkylene oxides.

In a preferred embodiment of the invention, 1,2-ethanediol, 1,3-propanediol, 2-methyl-1,3-propanediol, 1,4-butanediol, 1,6-hexanediol, 2,2-dimethyl-1,3-propanediol, 1,4-cyclohexanedimethanol, 1,4-diethanolcyclohexane, and ethoxylated or propoxylated products of 2,2-bis(4-hydroxyphenylene)propane (bisphenol A) are used. Depending on the desired properties of the thermoplastic polyurethanes equipped with the corresponding soft segments, the named polyester polyols can be used alone or as a mixture of two or more of the named polyester polyols in various proportions for the production of the thermoplastic polyurethanes. As lactones for the production of the polyester polyols, for example, α,α-dimethyl-γ-propiolactone, β-butyrolactone, and ε-caprolactone are suitable.

The polyether polyols are likewise suitable for use as soft segments B in the production of the above-mentioned thermoplastic polyurethanes. Polyether polyols are understood to mean essentially linear substances featuring OH end groups as mentioned above, with ether bonds. Suitable polyether polyols can be produced, for example, by polymerization of cyclic ethers such as tetrahydrofuran or by reaction of one or more alkylene oxides with 2 to 4 C atoms in the alkylene radical with a starter molecule that features two active hydrogen atoms. As alkylene oxides, for example, ethylene oxide, 1,2-propylene oxide, epichlorohydrin, 1,2-butylene oxide or 2,3-butylene oxide, or mixtures of two or more thereof, are suitable.

The alkylene oxides can be used individually, alternating one after the other, or as mixtures of two or more of the named alkylene oxides. As the starter molecule, for example water, glycols such as ethylene glycol, propylene glycol, 1,4-butanediol, 1,5-pentanediol and 1,6-hexanediol, amines such as ethylenediamine, 1,6-hexamethylenediamine, or 4,4′-diaminodiphenylmethane as well as aminoalcohols such as methylethanolamine are suitable. In principle, however, all the above-mentioned at least difunctional compounds, as described for the build-up of the soft segments, can be used as starter molecules. EP-B 0 416 386, for example, cites suitable polyester polyols and polyether polyols, as well as their production.

For example aliphatic alcohols with three or more functional groups and 3 to about 15, preferably about 3 to about 10, C atoms can also be used in the production of the soft segments, in amounts of up to about 5% by weight relative to the total mass of the soft segments contained in the thermoplastic polyurethane. Correspondingly suitable compounds are for example trimethylolpropane, triethylolpropane, glycerol, penta-erythritol, sorbitol, mannitol, and further sugar alcohols with up to about 10 OH groups per molecule. The corresponding derivatives of the named compounds, such as can be obtained by reaction with an alkylene oxide with 2 to about 4 C atoms or a mixture of two or more such alkylene oxides, can likewise be used for the production of the soft segments. In a further variant, carboxylic acids or derivatives thereof with three or more functional groups can also be used. The named compounds can respectively be used alone or also as mixtures of two or more of the named compounds.

In a preferred embodiment of the invention, the soft segments B feature glass transition temperatures of about −50° C. to about 40° C., in particular −40° C. to 20° C. In a further particularly preferred embodiment of the invention, the glass transition temperatures of the soft segments B are in a range of about −30° C. to about 0° C. In order to guarantee the desired mechanical properties of the thermoplastic polyurethane according to the invention, the soft segment B should feature a molecular weight of about 500 to about 100 000 g/mol. In a preferred embodiment of the invention, soft segments B are used that feature a molecular weight of about 1,500 to about 15,000 g/mol, for example, about 2000 to about 10,000 g/mol, preferably about 3000 to 8000 g/mol.

Compounds of the above-mentioned compound classes suitable for use as soft segments B can already be present in a molecular weight range suitable for use as soft segment B. It is equally possible, however, to use compounds of the above-mentioned compound classes for the production of soft segments B that feature a molecular weight below the molecular weight suitable for use as soft segment B or desired molecular weight. In this case it is possible in the scope of the present invention to lengthen such compounds of the above-mentioned compound classes by reaction with corresponding difunctional compounds until the required or desired molecular weight is reached. Depending on the end group X, for example dicarboxylic acids, difunctional epoxy compounds or diisocyanates are suitable for this, whereby in a preferred embodiment of the present invention, diisocyanates are used.

In principle di- or higher-functional compounds that lead to a glass transition temperature of the lengthened soft segment B within the desired range, are used for the above-mentioned increase in molecular weight. Thus in a preferred embodiment of the invention in the stated case, compounds such as polyisocyanates, in particular diiso-cyanates and triisocyanates, in particular, for example, those with 6 to about 30 C atoms, are used to increase the molecular weight in the production of the soft segments B. Individually, the following are to be named, for example: linear aliphatic diisocyanates such as 1,4-tetramethylene diisocyanate, 1,5-pentamethylene diisocyanate, or 1,6-hexamethylene diisocyanate, aliphatic cyclic diisocyanates such as 1,4-cyclohexylene diisocyanate, dicyclohexylmethane diisocyanate, or isophorone diisocyanate (IPDI). Also suitable as diisocyanates in the scope of the present invention are aromatic diisocyanates such as toluylene 2,4-diisocyanate (2,4-TDI), toluylene 2,6-diisocyanate (2,6-TDI), the isomer mixture of the last two diisocyanates named, m-tetramethylxylylene diisocyanate (TMXDI), p-tetramethylxylylene diisocyanate, 1,5-naphthylene diisocyanate, 1,5-tetrahydronaphthylene diisocyanate, 2,2′-diphenylmethane diisocyanate, 2,4′-diphenylmethane diisocyanate, and 4,4′-diphenylmethane diisocyanate (MDI), as well as mixtures of two or more of the named diisocyanates. The triisocyanates used can be biurets or allophanates. In a preferred embodiment of the invention, diisocyanates are used that feature an aromatic molecular constituent.

The soft segments B can optionally carry one or more anchor groups L. Soft segments B with anchor groups L are produced according to the customary rules of organic chemistry, for example as described in the further course of the text in the context of the production of the hard segments A carrying anchor groups. In a preferred embodiment of the present invention, however, the thermoplastic polyurethanes carry more anchor groups in the hard segment than in the soft segments. In a preferred embodiment of the invention, the ratio of anchor groups in the hard segments to anchor groups in the soft segments is at least about 5:1, for example at least about 10:1. In a further preferred embodiment of the invention, the soft segments B contained in the thermoplastic polyurethane feature no anchor groups.

The production of the segment G with at least one anionic anchor group L and also the production of the hard segment A preferably takes place via regulated radical polymerization of suitably functionalized monomers with thioethanol or thioacetic acid. Suitable monomers are, for example, derivatives of acrylic acid and methacrylic acid with polar groups, for example esterification products of acrylic acid and methacrylic acid with an alcohol component with a C₁- to C₂₅-alkyl radical or with an alkyl radical substituted with a heteroatom such as O, S, or N, or polar vinyl monomers, or combinations of two or more of these monomers or combinations of one or more of these monomers with at least one less polar monomer. The production of a hard segment A takes place in such a way that a compound appropriately functionalized with an anionic anchor group L is already used in the build-up of the segment G and thus the latter is already built into the hard segment A during the synthesis of the hard segment A. Suitable monomers for the introduction of the anchor group L are, for example, 2-acrylamido-2-methylpropanesulfonic acid and preferably its salts, particularly preferred its ammonium salts, or 3-sulfopropyl methacrylate Na salt. Preferred monomers for the production of the hard segment A and the segment G are selected from the group comprising: 2-acrylamido-2-methylpropanesulfonic acid and preferably its salts, particularly preferred its ammonium salts, or 3-sulfopropyl methacrylate Na salt, acrylamide, acrylonitrile, methacrylamide, methacrylonitrile, N-vinylformamide, N-vinylpyrrolidone, N-vinylcaprolactam, N-vinylimidazole, methyl methacrylate (MMA), butyl methacrylate (BMA), ethyl acrylate, isopropyl acrylate, n-butyl acrylate, 2-ethylhexyl acrylate, hydroxypropyl methacrylate, hydroxypropyl acrylate, HEMA, HEA, glycidol acrylate, GMA, isobornyl acrylate, 2-(N,N-dimethylamino)ethyl methacrylate, vinyl acetate, vinyl propionate, vinyl chloride, styrene, alkylated styrenes, methoxystyrenes.

In a preferred embodiment of the invention, the hard segment A corresponds to the segment G.

The number of anchor groups L per hard segment A can vary within wide limits, whereby respectively the solubility in compatible solvents, such as, e.g., THF or dioxane, is the limiting factor. If a thermoplastic polyurethane according to the invention features only one hard segment A (shown in the general formula I or Ia, where n and k stand for the number 1 or in the general formula II or IIa, where n stands for the number 1), the number p in formula Ia, which gives the number of anchor groups L in the hard segment A, stands for a number greater than 0 to 10. In a preferred embodiment of the invention, p stands for 1. When the thermoplastic polymer features more than one hard segment A, for example shown in the general formula I or Ia, where n or k stands for a number greater than 1, it is not absolutely necessary in the scope of the present invention for each hard segment A in the thermoplastic polymer to carry an anchor group L or two or more anchor groups L. It is merely necessary that at least one hard segment in the thermoplastic polymer carries an anchor group L. It is likewise provided in the scope of the present invention that two or more hard segments A in a single thermoplastic polymer feature a different number of anchor groups. Accordingly, a thermoplastic polyurethane that can be used in the scope of the present invention, in so far as it features two or more hard segments A, can feature respectively hard segments A without anchor groups L, with one anchor group L, or with two or more anchor groups L, whereby at least one of the hard segments A must carry at least one anchor group L. The formula spelling A(L), as used for example in formula Ia and formula IIa, is therefore not to be understood to mean that each hard segment A must carry an anchor group L. The only crucial point is that at least one hard segment in the thermoplastic polyurethane carries at least one anchor group L. This means that relative to the totality of the molecules, the number of anchor groups L can also have a non-integral value less than 1.

The parameter p, as used in formula Ia and IIa, therefore does not have to stand for an integer, but can have values that include the total number spectrum lying within the limits for p.

In accordance with the conditions in the polymer synthesis, the parameter n likewise does not necessarily have to stand for an integer, since as a rule molecules with different molecular weights are formed in polymer syntheses and thus the number n can be different for molecules formed during the polymer synthesis. The parameter n thus expresses in the present case the average number of the repeat units in the totality of the polymer molecules viewed.

In a preferred embodiment of the invention, a hard segment A contains the already defined anchor groups L.

In a preferred embodiment of the invention, the hard segments A feature glass transition temperatures of more than the service temperature of a magnetic storage medium produced from the polyurethanes according to the invention, for example, of about 20° C. to about 90° C. In a further preferred embodiment of the invention, the glass transition temperatures of the hard segments A lie in a range of about 20° C. to about 80° C., for example in a range of about 40° C. to about 70° C. In order to guarantee the desired mechanical properties of the thermoplastic polyurethane according to the invention, the hard segments A should feature a molecular weight (M_{w}) of about 1000 to about 50,000 g/mol. In a preferred embodiment of the invention, hard segments A are used that feature a molecular weight of about 1,500 to about 20,000 g/mol, for example about 3,000 to about 10,000 g/mol.

The production of the soft segments B and the hard segments A is carried out according to the customary rules of organic polymer chemistry. If a polyester, a polyether, a polycarbonate, a polyacetal, or another compound that can be used as a soft segment, is used as a soft segment, its production is carried out according to customary methods of polymer chemistry known to one skilled in the art. If various of the named compounds that can be used as a soft segment are to be bound together due to a too low molecular weight of the individual compounds, this is likewise done according to the customary rules known in organic chemistry for the respective functional groups, depending on the difunctional compound used for the chain lengthening.

The production of the soft segments B is carried out in such a way that a soft segment B is formed that features at least two functional groups Y, whereby a group Y is capable of reacting with a reactive group X, preferably an OH group, forming a covalent bond. Suitable groups Y have already been named in the course of this text. In a preferred embodiment of the invention, soft segments B that carry isocyanate groups as functional groups Y are used for the production of the thermoplastic polyurethanes. The number of functional groups Y per soft segment should be at least about two. However, it is equally possible to use soft segments whose functionality is higher than two, for example, about 3. It is furthermore possible to use mixtures of two or more different soft segments B, for example, whose functionality differs with respect to reactive groups X. Thus it is quite possible in the scope of the present invention for the soft segments B used to feature a functionality with respect to hydroxy groups that lies, for example, between 2 and 3, for example, about 2.1 to about 2.5.

In a preferred embodiment of the invention, polyester polyols, polyether polyols, or polycarbonate polyols are used as soft segments B that were lengthened if necessary with diisocyanates, for example diphenylmethane diisocyanate or toluylene diisocyanate, until an appropriate molecular weight was achieved.

The compounds used as hard segments A in the scope of the present invention are produced in the scope of a preferred embodiment in such a way that after their production, polymers are present that can be used as hard segments and have at least two reactive groups X, preferably OH groups. In a preferred embodiment of the invention, the compounds that can be used as hard segments feature at least two OH groups as end groups.

The thermoplastic polyurethanes according to the invention can be produced in principle in two different ways. In both cases the hard segment A is first produced by regulated radical polymerization. This hard segment block A features functional groups X in the scope of the invention. In the scope of the present invention, a hard segment block A can be reacted with a soft segment block B, forming at least one covalent bond. Alternatively, the build-up of the soft segment block B can take place directly during the reaction with the hard segment block A. Suitable compounds for the reaction with the hard segment block A for the build-up of a soft segment block B are those named previously for the build-up of the soft segment block B of the general form Y-B-Y. The structures given represent merely schematically the build-up of the compounds to be reacted together. The number of the functional groups can vary from the form shown structurally, in accordance with what has been said above. As already explained above, not all compounds used for the formation of hard segments A need to feature one or more anchor groups. It is only necessary to add a sufficient number of compounds carrying anchor groups L so that the thermoplastic polyurethane features at least one hard segment that carries at least one anchor group L. A structure B-A-B is thereby preferred, whereby the hard segment A carries at least one anchor group L.

The subject of the present invention is therefore also a method for the production of a thermoplastic polyurethane according to the invention. It is in particular a method for production in which at least one segment A that is difunctional at least with respect to Y, in particular NCO groups, and that includes at least one segment G containing a polymer block built up from unsaturated monomers, is reacted. In a preferred embodiment the segment G is a polyacrylate- or a polymethacrylate block.

The reaction of a hard segment block with functional groups X and a soft segment block B with at least two functional groups Y can be undertaken in a manner known per se, preferably at temperatures of about 0 to about 120° C. The ratio of the two components is advantageously selected such that the ratio of X to Y groups is about 1 to about 2. Following the customary rules of polymer chemistry, the molecular weight of the thermoplastic polyurethanes obtained can be controlled within wide limits by appropriate variations of the stated ratio.

Further low-molecular compounds can optionally be present as additives during the reaction. Such compounds can act for example as chain lengtheners or shortstop reagents. Primary amino compounds with two to about 20, for example 2 to about 12, C atoms are suitable for this for example. For example these are ethylamine, n-propylamine, i-propylamine, sec-propylamine, n-butylamine, tert-butylamine, 1-aminoisobutane, substituted amines with two to about 20 C atoms such as 2-(N,N-dimethylamino)-1-aminoethane, aminomercaptans such as 1-amino-2-mercaptoethane, diamines, aliphatic amino alcohols with I to about 20, preferably 1 to about 12 C atoms, for example methanolamine, 1-amino-3,3-dimethylpentan-5-ol, 2-aminohexane-2′,2″-diethanolamine, 1-amino-2,5-dimethylcyclohexan-4-ol, 2-amino-1-propanol, 2-amino-1-butanol, 3-amino-1-propanol, 1-amino-2-propanol, 2-amino-2-methyl-1-propanol, 5-amino-1-pentanol, 3-aminomethyl-3,5,5-trimethylcyclohexan-1-ol, 1-amino-1-cyclopentanemethanol, 2-amino-2-ethyl-1,3-propanediol, aromatic-aliphatic or aromatic-cycloaliphatic amino alcohols with 6 to about 20 C atoms, whereby as aromatic structures, heterocyclic ring systems or preferably isocyclic ring systems such as naphthalene- or in particular benzene derivatives such as 2-aminobenzyl alcohol, 3-(hydroxymethyl)aniline, 2-amino-3-phenyl-1-propanol, 2-amino-1-phenylethanol, 2-phenylglycinol, or 2-amino-1-phenyl-1,3-propanediol are suitable, as well as mixtures of two or more such compounds.

The reaction can optionally be carried out in the presence of a catalyst. In a preferred embodiment, this is for example a tertiary amine such as triethylamine, tributylamine, diazabicyclo[2.2.2]octane, N-methylpyridine, or N-methylmorpholine. Further suitable catalysts are organometallic compounds such as dibutyltin dilaurate and metal salts such as tin octoate, lead octoate, or zinc stearate. The amount of catalyst present during the reaction is generally about 1 to about 500 ppm by weight.

The concomitant use of a solvent or diluent is not required as a rule. In the scope of a preferred embodiment, however, a solvent or a mixture of two or more solvents is used. Suitable solvents are, for example, hydrocarbons, in particular toluene, xylene or cyclohexane, esters, in particular ethyl glycol acetate, ethyl acetate or butyl acetate, amides, in particular dimethylformamide or N-methylpyrrolidone, sulfoxides, in particular dimethyl sulfoxide, ethers, in particular diisopropyl ether or methyl tert-butyl ether or preferably cyclic ethers, in particular tetrahydrofuran or dioxane.

A binding agent composition at least containing one thermoplastic polyurethane according to the invention is likewise a subject of the invention.

The binding agent composition according to the invention contains at least one thermoplastic polyurethane that features at least one segment G, whereby this segment G containing monomers linked by radical polymerization carries at least one anchor group L. Preferably the binding agent composition according to the invention contains at least one thermoplastic polyurethane that features at least one hard segment A and at least one soft segment B, whereby the segment G is situated in the hard segment A or in the soft segment B or in A and B. In a preferred embodiment of the present invention, the binding agent composition according to the invention contains such a thermoplastic polyurethane or a mixture of two or more such thermoplastic polyurethanes in an amount of at least about 10% by weight, for example, at least about 30 or 50% by weight. In a preferred embodiment of the invention, the content of polyurethane according to the invention in the binding agent composition is about 50±5% by weight, whereby the remainder can comprise conventional polymers suitable for use in the binding agent composition, for example polyurethanes. In addition to the named thermoplastic polyurethanes that carry an anchor group L in at least one hard segment A, the binding agent composition according to the invention can also contain a further thermoplastic polyurethane or a mixture of two or more further thermoplastic polyurethanes.

In the scope of a further preferred embodiment of the present invention, the binding agent compositions according to the invention also contain at least one further binding agent in addition to the already named thermoplastic polyurethane or the already named thermoplastic polyurethanes.

In addition to the named thermoplastic polyurethanes according to the invention or their mixtures, the binding agent compositions according to the invention can also contain a further polymer or a mixture of two or more further polymers. The further polymers that can be used in the scope of the binding agent composition according to the invention include, for example, non-thermoplastic polyurethanes, polyacrylates, polyester polyurethanes, poly(meth)acrylate urethanes, polymethacrylates, polyacrylamides, polymers or copolymers of vinyl monomers such as styrene, vinyl chloride, vinyl acetate, vinyl propionate, binding agents based on vinyl formals, cellulose-containing polymers such as cellulose esters, in particular cellulose nitrates, cellulose acetates, cellulose acetopropionate or cellulose acetobutyrate, phenoxy resins or epoxy resins, such as can be obtained in a manner known per se, or mixtures of two or more thereof.

The binding agent compositions according to the invention contain the thermoplastic polyurethanes as a rule in an amount of up to about 100% by weight. Further binding agents can be contained in the binding agent composition according to the invention in a proportion of up to about 90% by weight, for example, up to about 80, 70, 60, 50, 40, or 30% by weight, or lower.

The polyurethanes according to the invention can be used in a binding agent composition both as dispersing binding agents and coating application binding agents. When a polyurethane according to the invention is to be used as a dispersing binding agent, the number of anchor groups per hard segment in the polymer should be at least about 1, in particular about 1 to about 3. When a polyurethane according to the invention is to be used as a coating application binding agent, the number of anchor groups per hard segment in the polymer should be about 0.1 to about 0.9, in particular about 0.2 to about 0.6. The same applies if mixtures of two or more polymers are used for the production of the dispersing—or coating application binding agents. In this case the proportion of hard segments with anchor groups to hard segments without anchor groups should be adjusted so that the above-mentioned values are met.

In the scope of a preferred embodiment of the invention, polymers according to the invention that are suitable for use as dispersing binding agents feature a glass transition temperature (T_{g}) of about 50 to about 70° C. and a molecular weight of about 10,000 to about 25,000. In the scope of a preferred embodiment of the invention, polymers according to the invention that are suitable for use as coating application binding agents feature a glass transition temperature (T_{g}) of about 12 to about 30° C. and a molecular weight of about 40,000 to about 80,000.

In the scope of a preferred embodiment of the invention, the binding agents according to the invention contain a magnetic pigment or a mixture of two or more magnetic pigments and are suitable as a magnetic dispersion or as a constituent thereof. As magnetic pigments, the customary oxidic pigments are suitable, such as γ-Fe₂O₃, Fe₃O₄, FeOₓ(1.33<x<1.5), CrO₂, Co-modified γ-Fe₂O₃, Co-modified Fe₃O₄, Co-modified FeOₓ (1.33<x<1.5), ferromagnetic metal pigments or metal alloy pigments, barium ferrite or strontium ferrite. The metal pigment or metal alloy pigment includes a metal, such as e.g. Fe, Co, Ni, or a combination of two or more of these metals as a main constituent, as well as optionally further metal constituents such as e.g. Al, Si, S, Sc, Ti, V, Cr, Cu, Y, Mo, Rh, Pd, Ag, Sn, Sb, Te, Ba, Ta, W, Re, Au, Hg, Pb, Fe, Bi, La, Ce, Pr, Nd, P, Co, Mn, Zn, Ni, Sr, B. Further elements or compounds can be admixed with these pigments, as is generally customary.

Moreover the binding agent compositions according to the invention can also contain fillers, dispersing auxiliaries, further additives such as slip additives, carbon black, or non-magnetic inorganic or organic pigments.

Thus for the production of the magnetic dispersions according to the invention, a thermoplastic polyurethane or a mixture of two or more of the above-mentioned thermoplastic polyurethanes can be jointly dispersed with a magnetic pigment or a mixture of two or more magnetic pigments, for example in a mixture with one or more solvents and optionally jointly with fillers, dispersing auxiliaries, further binding agents and further additives such as slip additives, carbon black, or non-magnetic inorganic or organic pigments. In a preferred embodiment, the main components in the magnetic dispersion, i.e. in particular the pigments and the binding agent, are first mixed with the addition of a little solvent to produce a dough-like mass, and then are mixed together intimately, e.g., by kneading, and only then are they dispersed.

As slip additives, for example carboxylic acids with about 10 to about 20 C atoms can be used, in particular stearic acid or palmitic acid or derivatives of carboxylic acids such as their salts, esters, or amides, or mixtures of two or more thereof.

As non-magnetic inorganic additives, for example aluminum oxide, silicon dioxide, titanium dioxide, or zirconium dioxide are suitable, and as non-magnetic organic pigments, for example polyethylene or polypropylene are suitable.

In the scope of their use in magnetic recording media, the binding agent compositions according to the invention can be applied for example onto customary rigid or flexible supporting materials. As supporting materials, for example films of linear polyesters such as polyethylene terephthalate or polyethylene naphthalate that feature in general thicknesses of about 4 to about 200 μm, in particular about 5 to about 36 μm, are suitable.

It has surprisingly proved that, compared to pure polyurethanes, the use of the polyurethanes according to the invention leads to pigmented binding agent films that dry from THF/MiBK solvent mixtures with less tension and thus lead to less cupping of the tapes. Since the cupping of the tapes can lead to abrasion when they are in contact with the magnetic head and the tape-head contact is disturbed, tension-free drying of the films is of great interest.

The subject of the invention is therefore also a molded article, in particular a self-supporting molded article, at least containing one binding agent composition according to the invention or a binding agent composition produced according to a method according to the invention.

The subject of the invention is likewise the use of a binding agent composition according to the invention or a binding agent composition produced according to the invention, for the production of magnetic recording media. The following are to be named in particular as recording media:

video cassettes, for both the professional and consumer sectors, audio cassettes for both the professional and consumer sectors, e.g., digital audio tape; data storage tapes; diskettes; floppy disks; ZIP disks; magnetic strips.

In a preferred embodiment, such a recording medium has a double-layer structure.

The invention is explained below in more detail by means of examples.

### EXAMPLES

Synthesis of the Polyacrylate Block:

### Example 1

225.0 g of tetrahydrofuran and a freshly prepared solution of 25.74 g of 2-acrylamido-2-methylpropanesulfonic acid, 23.01 g of tributylamine, and 26.25 g of tetrahydrofuran were first placed in a stirring apparatus with 2 metering pumps for the feeds and were heated to boiling point. Then the two feeds, comprising feed 1a (435.0 g of methyl acrylate, and 14.25 g of 2-hydroxyethyl acrylate) and feed 1b (4.13 g of 2-mercaptoethanol, 0.75 g of α,α′-azoisobutyronitrile, and 30.0 g of tetrahydrofuran), were added simultaneously via the metering pumps within 120 min. The further polymerization took place at 80° C. external temperature and was terminated at a monomer content <1% (determined by gas chromatography). Then the polymer solution was diluted with 210.0 g of tetrahydrofuran, which gave a solids content of 50%.

### Example 2

The polyacrylate, which contained sulfonate groups and OH end groups, was produced by radical polymerization of 1.99 mol of 2-acrylamido-2-methylpropanesulfonic acid tributylamine salt, 69.81 mol of methyl methacrylate, and 1.97 mol of 2-hydroxyethyl acrylate with 0.08 mol of α,α′-azoisobutyronitrile as a starter and 0.85 mol of 2-mercaptoethanol as a regulator. The polymerization was carried out 50% in tetrahydrofuran at 70° C.

Synthesis of the Binding Agent

### Example 3

1 mol of a polyacrylate that contained sulfonate groups and OH end groups (e.g. Example 1) and 11.25 mol of a polyester diol with a molar mass of about 800 comprising adipic acid, isophthalic acid, and 1,4-cyclohexanedimethanol, were reacted in tetrahydrofuran with 11.88 mol of 4,4′-diphenylmethane diisocyanate at 60° C. At a viscosity of the 43% solution of 2000 mPas (at 60° C.), an amount of dibutylamine equivalent to the still present isocyanate was added.

### Example 4

1 mol of a polyacrylate that contained sulfonate groups and OH end groups (e.g. Example 1) and 11.25 mol of a polyester diol with a molar mass of 800 comprising adipic acid, isophthalic acid, and 1,4-cyclohexanedimethanol, were reacted in tetrahydrofuran with 11.31 mol of 4,4′-diphenylmethane diisocyanate at 60° C. The reaction temperature is maintained until the amount of isocyanate groups present is zero.

Comparative Measurements for Cupping

### Example 5

Test Formulation Phase 1:

180 g of pigment, 3.6 g of stearic acid, 26 g of dispersing binding agent in 28% solution in THF/MiBK (3:1), dispersion in a stirred mill.

Phase 2:

26 g of binding agent, 24% solution in THF/MiBK (3:1)

Cupping of the doctor films from the corresponding solutions with an 80 μm doctor knife on PET film (thickness of the film: 24 or 75 μm, respectively):

For the example according to the invention (polymethacrylate-containing binding agent) and the comparative example (Morthane CA 151), the cupping after the dispersion according to Phase 1 was first measured in the respective binding agent. Then in Phase 2 the second binding agent, i.e. the polymethacrylate-containing binding agent according to the invention or Morthane CA 152, was added and the cupping was again measured.

TABLE 1

| | | | Phase 2 with poly- |
|---|---|---|---|
| | | | methacrylate- |
| | | Phase 2 with | containing binding |
| | Phase 1 | Morthane CA 152 | agent |
| Polymethacrylate- | slight | strong | none |
| containing binding | | | |
| agent | | | |
| Morthane CA 151 | strong | strong | — |

Binding Agent for Phase 2:

Polybutyl methacrylate copolymer with 2-hydroxyethyl methacrylate and AMPS polymerized regulated with thioethanol. The binding agent was then obtained by reacting the polymethacrylate block with polyester VP9184 (BASF), 1,4-cyclohexanedimethanol, and MDI.

Dispersions

### Example 6

In a 1.5-L stirred ball mill filled with 2.7 kg of ceramic balls with a diameter of between 1.0 and 1.5 mm,

4200 g of an organic solvent mixture comprising 80% THF and 20% isobutyl methyl ketone

930 g of a solution of the polymer according to the invention, 15% in THF

500.4 g of a solution of a commercially available polyurethane with sulfonate anchor groups (Morton company), 25% in THF

1200 g of a ferromagnetic metal pigment (Hc=127 kA/m); SSA=58 m²/g; average particle size 170 nm, average particle diameter 25 nm)

110 g of α-aluminum oxide (average particle diameter 320 nm)

12 g of carbon black (BET=60 m²/g; primary particle size 30 nm)

12 g of stearic acid

9 g of fatty acid ester as a slip additive

are placed and dispersed for 6 h. The dispersion produced in this manner is homogeneous, fine-particle, settling-resistant, and flocculate-free. Then the dispersion was filtered under pressure through a filter (pore size 3 μm).

Immediately before the coating, 42 g of a 50% solution of the reaction product of 3 mol of toluylene 2,4-diisocyanate (TDI) with 1 mol of trimethylol propane in THF was added to the dispersion under vigorous stirring.

The dispersion was applied to a back-coated polyethylene terephthalate film with a dry layer thickness of 3 μm. Before the drying, the coated web was conducted through a directing zone comprising a coil with the field strength of 200 kA/m in order to align the ferromagnetic pigments. After the drying at 80° C., the film web was calendered in a steel/steel calender with 6 gaps at 85° C. and a pressure of 200 kg/cm and was then cut into ½-inch wide video tapes.

### Comparative Example

The procedure was as described above, but the polyurethane according to the invention was replaced with respect to weight by a commercially available VC copolymer with sulfonate anchor groups (Nippon Zeon company).

Table 2 shows the measurement results obtained.

TABLE 2

| | Example 6 | Comparative example |
|---|---|---|
| Duration of the dispersing | 8 | 11 |
| Gloss 1 | 125 | 110 |
| Gloss 2 | 125 | 105 |
| Surface defects | None | None |
| HF level (dB) | +1.5 | 0 |
| S/N (dB) | +0.8 | −0.4 |
| Abrasion at video head | 2.0 | 4.0 |
| (Note) | | |
| Friction coefficient | 0.21 | 0.25 |
| RAF test | | |

The meaning of the measurement values (Table 2) is as follows:

Gloss Measurement:

A reflection at an angle of 60° is measured on the uncalendered layer.

Gloss 1: Gloss value immediately after the end of the dispersing

Gloss 2: Gloss value after 24 h rolling board

The higher the gloss value, the better the pigment distribution.

HF Level:

The high frequency level was measured in a Betacam SP recorder (System BVW 75, Sony company) against the reference tape Sony RSB 01 SP. The higher the HF level, the better the tape.

S/N (Luminance):

The luminance signal was measured in a Betacam SP recorder (System BVW 75, Sony company) against the reference tape Sony RSB 01 SP. The higher the S/N value, the better the tape.

Friction Coefficient:

The friction coefficient with the RAF test was determined over a sample length of 150 mm for a measurement distance of 100 mm. After 15 min conditioning at 40° C. and 80% relative air humidity, the piece of tape was pulled to and fro over a steel pin (diameter 2.5 mm, looping angle 90°) for a length of 100 mm with a force of 2 N and at a rate of 20 mm/s. The friction coefficient was measured after 100 cycles in the above-mentioned climatic conditions. The smaller the value, the better the running properties of the tape.

### Example 7

Monolayer Tape:

A mixture of 100 parts by weight of a ferromagnetic metal pigment (Hc=117 kA/m; SSA=51 m²/g, average particle length 170 nm, average particle diameter 25 nm), 10 parts by weight of α-aluminum oxide (average particle diameter 320 nm), 2 parts by weight of carbon black (BET=35 m²/g; primary particle size=50 nm), 9 parts by weight of the polymer according to the invention, 9 parts by weight of a commercially available polyurethane with sulfonate anchor groups (Morton company), 2.5 parts by weight of stearic acid, 15 parts by weight of tetrahydrofuran, and 15 parts by weight of dioxane was kneaded in a batch kneader (IKA high-performance kneader type HKD 10, IKA-Maschinenbau company, Staufen) for 2 h.

A mixture of 145 parts by weight of THF and 145 parts by weight of dioxane was then added to the kneaded mass in portions in a dissolver under vigorous stirring and the mixture was dispersed with a stirred mill for 9 h. Then 1 part by weight of butyl stearate, 5.2 parts by weight of a 50% by weight solution of the reaction product of 3 mol of toluylene diisocyanate and 1 mol of trimethylol propane in THF were added to the dispersion under vigorous stirring, as well as a mixture of 40 parts by weight of THF and 40 parts by weight of dioxane in portions. After filtration through a filter with a pore size of 2 μm, a homogeneous, fine-particle, settling-resistant, and flocculate-free coatable dispersion was obtained.

The dispersion was applied to a back-coated polyethylene terephthalate film with a dry layer thickness of 3 μm. Before the drying, the coated web was conducted through a directing zone comprising a coil with a field strength of 200 kA/m in order to align the ferromagnetic pigments. After the drying at 80° C., the film web was calendered in a steel/steel calender with 6 gaps at 85° C. and a pressure of 200 kg/cm and was then cut into ½-inch wide video tapes.

### Comparative Example

The procedure was as described above, but the polyurethane according to the invention was replaced with respect to weight by a commercially available VC copolymer with sulfonate anchor groups (Nippon Zeon company). Table 3 shows the measurement results obtained.

TABLE 3

| | Example 7 | Comparative example |
|---|---|---|
| Duration of kneading + dispersing (h) | 2 + 9 | 2 + 13 |
| Gloss 1 | 140 | 115 |
| Gloss 2 | 138 | 105 |
| Surface defects | None | None |
| HF level (dB) | +2.3 | +0.5 |
| S/N (dB) | +1.6 | +0.1 |
| Abrasion at video head (Note) | 1.5 | 3 |
| Friction coefficient RAF test | 0.21 | 0.29 |

The meaning of the measurement values (Table 3) is as follows:

Gloss Measurement:

A reflection at an angle of 60° is measured on the uncalendered layer.

Gloss 1: Gloss value immediately after the end of the dispersing

Gloss 2: Gloss value after 24 h rolling board

The higher the gloss value, the better the pigment distribution.

HF Level:

The high frequency level was measured in a Betacam SP recorder (System BVW 75, Sony company) against the reference tape Sony RSB 01 SP. The higher the HF level, the better the tape.

S/N (Luminance):

The luminance signal was measured in a Betacam SP recorder (System BVW 75, Sony company) against the reference tape Sony RSB 01 SP. The higher the S/N value, the better the tape.

Friction Coefficient:

The friction coefficient with the RAF test was determined over a sample length of 150 mm for a measurement distance of 100 mm. After 15 min conditioning at 40° C. and 80% relative air humidity, the piece of tape was pulled to and fro over a steel pin (diameter 2.5 mm, looping angle 90°) for a length of 100 mm with a force of 2 N and at a rate of 20 mm/s. The friction coefficient was measured after 100 cycles in the above-mentioned climatic conditions. The smaller the value, the better the running properties of the tape.

### Example 8

Double-layer Tape:

a) Top layer

A mixture of 100 parts by weight of a ferromagnetic metal pigment (Hc=180 kA/m; SSA=58 m²/g, average particle length 80 nm, average particle diameter 25 nm),13 parts by weight of a-aluminum oxide (average particle diameter 220 nm), 8.2 parts by weight of the polymer according to the invention, 3.5 parts by weight of a commercially available polyurethane with polar anchor groups (Morton company), 2 parts by weight of stearic acid, 1 part by weight of myristic acid, 15 parts by weight of tetrahydrofuran, and 15 parts by weight of dioxane was kneaded in a batch kneader (IKA high-performance kneader type HKD 10, IKA-Maschinenbau company, Staufen) for 2 h.

A mixture of 155 parts by weight of tetrahydrofuran and 155 parts by weight of dioxane was then added to the kneaded mass in portions in a dissolver under vigorous stirring and the mixture was then dispersed with a stirred mill for 10 h. Then 1 part by weight of butyl stearate, 4 parts by weight of a 50% by weight solution of the reaction product of 3 mol of toluylene diisocyanate and 1 mol of trimethylol propane in tetrahydrofuran were added to the dispersion under vigorous stirring, as well as a mixture of 44 parts by weight of tetrahydrofuran and 44 parts by weight of dioxane in portions. After filtration through a filter with a pore size of 2 μm, a homogeneous, fine-particle, settling-resistant, and flocculate-free coating-ready dispersion was obtained for the top layer.

### Comparative Example 8a

The procedure was as described above, but the polyurethane according to the invention was replaced by a commercially available VC copolymer with sulfonate anchor groups (Nippon Zeon company).

b) Bottom Layer

A mixture of 100 parts by weight of α-iron oxide (average particle length 118 nm, average particle diameter 28 nm, SSA=60 m²/g; Toda company), 29 parts by weight of carbon black (average primary particle size 25 nm, SSA=112 m²/g), 13 parts by weight of the polymer according to the invention, 7.5 parts by weight of a commercially available polyurethane with polar anchor groups (Tg=70° C.; Morton company), 7.5 parts by weight of a second commercially available polyurethane with polar anchor groups (Tg=35° C.; Morton company), 2 parts by weight of stearic acid, 27 parts by weight of tetrahydrofuran, and 27 parts by weight of dioxane was kneaded in a batch kneader for 3 h.

A mixture of 234 parts by weight of tetrahydrofuran and 234 parts by weight of dioxane was then added to the kneaded mass in portions in a dissolver under vigorous stirring and the mixture was then dispersed in a stirred mill for 15 h. Then 6.3 parts by weight of a 50% solution of the reaction product of 3 mol of toluylene diisocyanate with 1 mol of trimethylolpropane in tetrahydrofuran were added to the dispersion under vigorous stirring. After filtration through a filter with a pore size of 2 μm, a homogeneous, fine-particle, settling-resistant, and flocculate-free coating-ready dispersion was obtained.

### Comparative Example 8b

The procedure was as described above, but the polymer according to the invention was replaced by a commercially available VC copolymer with sulfonate anchor groups (Nippon Zeon company).

Application of Bottom and Top Layer:

The dispersions were applied wet-in-wet to the front side of a back-coated polyethylene terephthalate film. Before the drying, the coated film was conducted through a directing zone comprising a coil with a field strength of 200 kA/m in order to align the ferromagnetic pigments. After the drying at 80° C., the film web was calendered with a steel/steel calender with 6 gaps at 80° C. and a pressure of 200 kg/cm and was then cut into 6.35 mm-wide video tapes.

The measurement results obtained are shown in Table 4.

TABLE 4

| | Example 8 | Comparative example |
|---|---|---|
| Layer thickness top layer (μm) | 0.25 | 0.27 |
| Layer thickness bottom layer (μm) | 1.30 | 1.32 |
| Gloss 1 (top layer) | 165 | 156 |
| Gloss 2 (top layer) | 163 | 153 |
| Gloss 1 (bottom layer) | 148 | 139 |
| Gloss 2 (bottom layer) | 148 | 137 |
| Surface defects | None | None |
| HF level (dB) | +1.5 | +0.3 |
| Abrasion at video head | 2 | 3.5 |
| Friction coefficient RAF test | 0.17 | 0.25 |

Gloss, abrasion, and friction measurements were carried out as described in Example 7.

The high-frequency level was measured in a DVC-MAZ instrument (AJ D-750, Panasonic company) against the reference tape Panasonic APOG 0715-15.

A comparison of the measurement results shows that the magnetic tapes according to the invention, due to their improved pigment distribution in the top and bottom layer, feature improved level values. Moreover a good running and abrasion behavior is achieved in the recorder due to the very low friction values.

1. Polyurethane with at least one anionic anchor group L, whereby the anionic anchor group L is bound in the polyurethane to a segment G that contains monomers linked by radical polymerization.

2. Polyurethane according to claim 1, characterized in that it features a block structure or thermoplastic properties or both.

3. Polyurethane according to claim 1 or 2, characterized in that it features at least one hard segment A and at least one soft segment B, whereby the segment G is situated in the hard segment A or in the soft segment B or in A and B.

4. Polyurethane according to claim 3, characterized in that at least one hard segment A features at least one segment G.

5. Polyurethane according to claim 3 or 4, characterized in that it features a structure of the general form
-(AₖBₗ)ₙ- (I)
or
-(A(B)ₘ)ₙ- (II),
where A stands for a hard segment and B stands for a soft segment, k and n respectively stand for a number from 1 to 10, and l and m stand for a number from 0 to 10, whereby k, l, and m can be selected for each repeat unit independently of the next repeat unit.

6. Polyurethane according to claim 5, characterized in that l and m stand for a number from 1 to 10.

7. Polyurethane according to one of the previous claims, characterized in that the monomers in the segment G are derivatives of acrylic acid or methacrylic acid with polar groups, or polar or non-polar vinyl monomers or a combination of two or more thereof or a combination of one of these monomers with a less-polar monomer.

8. Polyurethane according to one of the previous claims, characterized in that the anionic anchor group L is a sulfonate.

9. Method for the production of a polyurethane according to one of claims 1 through 8, characterized in that in the production, at least one segment A is used that is difunctional at least with respect to NCO groups, and that includes at least one segment G containing a polymer block built up from monomers linked by radical polymerization.

10. Method according to claim 9, characterized in that the segment G is a polyacrylate- or polymethacrylate block.

11. Binding agent composition at least containing one thermoplastic polyurethane according to one of claims 1 through 8 or a polyurethane produced according to claim 9 or 10.

12. Magnetic dispersion at least containing one polyurethane according to one of claims 1 through 8 or a polyurethane produced according to claim 9 or 10 or a binding agent composition according to claim 11 and at least one magnetic or magnetizable pigment.

13. Magnetic recording medium, at least containing one polyurethane according to one of claims 1 through 8 or a polyurethane produced according to claim 9 or 10 or a binding agent composition according to claim 11 or a magnetic dispersion according to claim 12.

14. Use of a polyurethane according to one of claims 1 through 8 or produced according to claim 9 or 10, or of a binding agent composition according to claim 11, or of a magnetic dispersion according to claim 12 for the production of magnetic recording media.
